(19) United States
(12) Patent Application Publication
(10) Pub. No.: US 2023/0209027 A1
(43) Pub. Date: Jun. 29, 2023

(54) DISPLAY METHOD, PROJECTOR, AND STORAGE MEDIUM STORING PROGRAM

(71) Applicant: SEIKO EPSON CORPORATION, Tokyo (JP)

(72) Inventors: Hiroya SHIMOHATA, Osaka-shi (JP); Eiji MORIKUNI, Matsumoto-shi (JP)

(73) Assignee: SEIKO EPSON CORPORATION, Tokyo (JP)

(21) Appl. No.: 18/146,909

(22) Filed: Dec. 27, 2022

(30) Foreign Application Priority Data
Dec. 28, 2021 (JP) 2021-214250

(51) Int. Cl. H04N 9/31; G06V 10/44

(52) U.S. Cl. CPC H04N 9/3185; G06V 10/44

(57) ABSTRACT

A display method includes displaying a first image containing a first portion and a second portion different from the first portion on a screen by a projector, storing information representing a first shape which is a shape of the first portion when the screen is seen from a first direction, and, when the shape of the first portion as seen from the first direction changes to a shape different from the first shape, displaying, by the projector, a second image obtained by performing correction on the first image to make the shape of the first portion as seen from the first direction closer to the first shape, and not performing the correction on the second portion on the screen.

The present application is based on, and claims priority from JP Application Serial Number 2021-214250, filed Dec. 28, 2021, the disclosure of which is hereby incorporated by reference herein in its entirety.

### BACKGROUND

### 1. Technical Field

The present disclosure relates to a display method, a projector, and a storage medium storing a program.

### 2. Related Art

In related art, a technique of, when an image is projected using a projector, correcting distortion of the projected image is known. For example, in JP-A-2000-330507, image data input from an image source such as a personal computer and image data of an on-screen display menu output from an on-screen display menu generator are synthesized by a synthesis circuit. In a keystone distortion corrector, keystone distortion correction is performed on the image data of the synthesized image. Thereby, keystone distortion may be reduced with respect to not only the projected image but also the on-screen display menu projected on the screen.

The above described related art is based on the assumption that the image is projected on a flat screen. On the other hand, when a soft material e.g. cloth or thin synthetic resin is used as the screen, the position of the projection surface may three-dimensionally change by wind or the like. When the change occurs in the screen, a new visual effect may be provided depending on the way of correction.

### SUMMARY

A display method according to an aspect of the present disclosure includes displaying a first image containing a first portion and a second portion different from the first portion on a screen using a projector, storing information representing a first shape as a shape of the first portion when the screen is seen from a first direction, and, when the shape of the first portion as seen from the first direction changes to a shape different from the first shape, displaying a second image obtained by performing correction on the first image to make the shape of the first portion as seen from the first direction closer to the first shape, but not performing the correction on the second portion on the screen using the projector.

A projector according to an aspect of the present disclosure includes an optical device, and a control device controlling the optical device, wherein the control device executes: displaying a first image including a first portion and a second portion different from the first portion on a screen using the optical device, storing information representing a first shape as a shape of the first portion when the screen is seen from a first direction, and, when the shape of the first portion as seen from the first direction changes to a shape different from the first shape, displaying a second image obtained by performing correction on the first image to make the shape of the first portion as seen from the first direction closer to the first shape, but not performing the correction on the second portion on the screen using the optical device.

A non-transitory computer-readable storage medium according to an aspect of the present disclosure stores a program for causing a processing device to execute displaying a first image including a first portion and a second portion different from the first portion on a screen using a projector, storing information representing a first shape as a shape of the first portion when the screen is seen from a first direction, and, when the shape of the first portion as seen from the first direction changes to a shape different from the first shape, displaying a second image obtained by performing correction on the first image to make the shape of the first portion as seen from the first direction closer to the first shape, but not performing the correction on the second portion on the screen using the projector.

### BRIEF DESCRIPTION OF THE DRAWINGS

FIG. 1 shows a display system including a projector according to an embodiment.

FIG. 2 is a block diagram showing a configuration of the projector.

FIG. 3 shows types of images relating to the display system.

FIG. 4 schematically shows an example of an input image.

FIG. 5 is an explanatory diagram schematically showing an imaging range of an imaging device.

FIG. 6 schematically shows a method of receiving a designation of first portions by a designation acceptor.

FIG. 7 is an explanatory diagram schematically showing an image to be corrected.

FIG. 8 is an explanatory diagram schematically showing an example of a first captured image.

FIG. 9 is an explanatory diagram schematically showing an example of a second captured image.

FIG. 10 is an explanatory diagram schematically showing an example of a third captured image.

FIG. 11 is an explanatory diagram schematically showing a method of determining correction amounts.

FIG. 12 is an explanatory diagram schematically showing a method of determining correction amounts.

FIG. 13 is a flowchart showing a flow of a display method executed by a processing device of the projector according to a control program.

### DESCRIPTION OF EXEMPLARY EMBODIMENTS

As below, preferred embodiments according to the present disclosure will be explained with reference to the accompanying drawings. In the drawings, dimensions or scales of the respective parts are appropriately different from the real ones and some parts are schematically shown to facilitate understanding. The scope of the present disclosure is not limited to these embodiments unless otherwise specified to limit the present disclosure in the following description.

### A: Outline of Display System 1

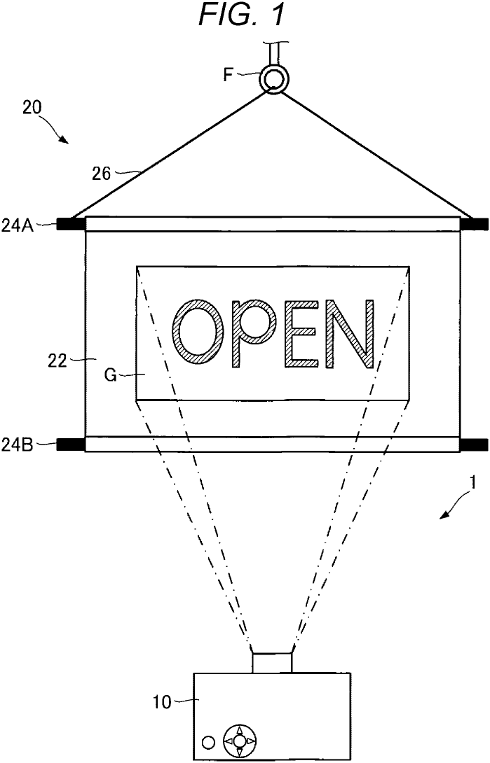

FIG. 1 shows a display system 1 including a projector 10 according to an embodiment. The display system 1 includes the projector 10 and a screen 20.

The projector 10 displays an image by projecting the image on the screen 20. The image projected by the projector 10 is referred to as “projected image G”. For example, the projector 10 is placed so that the projected image G is located on a cloth 22 of the screen 20. In the example of FIG. 1, the projected image G is placed to be superimposed on a center part of the cloth 22. The projector 10 may be placed on e.g. a desk, a table, or a floor or mounted on a ceiling or a wall.

The screen 20 is a member having a projection surface on which the projected image G is projected. In the embodiment, the screen 20 is a tapestry and includes the cloth 22, an upper bar 24A, a lower bar 24B, and a hanging string 26. The cloth 22 has a rectangular shape horizontally longer, and the upper bar 24A is attached along the upper side and the lower bar 24B is attached along the lower side. The hanging string 26 is attached to ends of the upper bar 24A and the screen 20 can be hung using a hook F or the like.

As shown in FIG. 1, the cloth 22 of the hanging screen 20 is tensed to form a flat surface along the direction of gravitational force by the weight of the lower bar 24. On the other hand, for example, in a case where an external force is applied to the screen 20 such that wind blows around the screen 20 or a person touches the screen 20, the cloth 22 may bend to form a non-flat surface.

The screen 20 is not limited to the tapestry, but may be e.g. a roll curtain placed near the window for sunshade, a banner, or a wall surface. The projection surface of the screen 20 is formed using, not limited to the cloth 22, but a synthetic resin such as plastic or paper. As below, a case where the shape of the screen 20 changes will be explained as an example, however, not limited to the case, but, for example, a relative position relationship between the projector 10 and the screen 20 may be changed. For example, the projector 10 may be hung by a string or the like and the angle of the projector 10 relative to the wall surface may be changed.

### B: Configuration of Projector 10

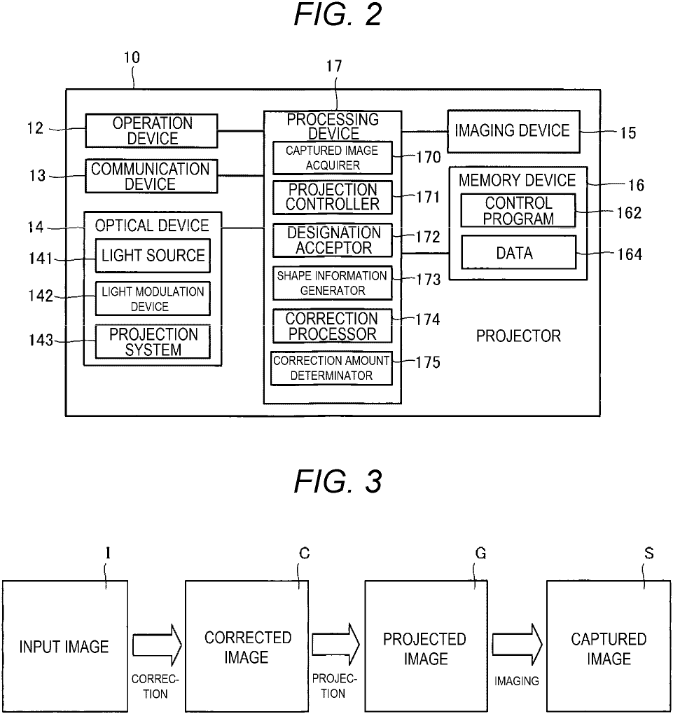

FIG. 2 is a block diagram showing a configuration of the projector 10. The projector 10 includes an operation device 12, a communication device 13, an optical device 14, an imaging device 15, a memory device 16, and a processing device 17.

The operation device 12 includes e.g. various operation buttons and operation keys, or a touch panel. The operation device 12 is provided in e.g. a housing of the projector 10. The operation device 12 may be a remote controller separately provided from the housing of the projector 10. The operation device 12 receives input operation from a user.

The communication device 13 is an interface communicably connected to an image supply apparatus such as a computer (not shown). The communication device 13 receives input image data as data of an input image I from the image supply apparatus. The communication device 13 is an interface e.g. wireless or wired LAN (Local Area Network), Bluetooth, USB (Universal Serial Bus), HDMI (High Definition Multimedia Interface), or the like. The Bluetooth, the USB, and the HDMI are respectively registered trademarks. The communication device 13 may be connected to the image supply apparatus via another network such as the Internet. The communication device 13 includes an interface such as an antenna for wireless connection or a connector for wired connection and an interface circuit electrically processing a signal received via the interface.

The optical device 14 projects the projected image G within a projectable range NA based on an image signal from the processing device 17. For example, the projectable range NA is shown in FIG. 5. The projectable range NA is a range in which an image can be projected by the optical device 14. Generally, the housing of the projector 10 is placed so that the projectable range NA may be superimposed on the screen 20. The optical device 14 has a light source 141, a light modulation device 142, and a projection system 143.

The light source 141 includes e.g. a halogen lamp, a xenon lamp, a super high-pressure mercury lamp, an LED (Light Emitting Diode), or a laser beam source. For example, the light source 141 respectively outputs red, green, and blue lights or outputs a white light. When the light source 141 outputs a white light, the light output from the light source 141 has a luminance distribution with variations reduced by an optical integration system (not shown), and then is separated into red, green, and blue lights by a color separation system (not shown) and the lights enter the light modulation device 142.

The light modulation device 142 includes three light modulation elements respectively provided to correspond to red, green, and blue. Each light modulation element includes e.g. a transmissive liquid crystal panel, a reflective liquid crystal panel, or a DMD (digital mirror device) . The light modulation elements respectively modulate the red, green, and blue lights based on the image signal from the processing device 17 and generates image lights of the respective colors. The image lights of the respective colors generated by the light modulation device 142 are combined by a color combining system (not shown) into a full-color image light. The light modulation device 142 is not limited to that, but a full-color image light may be visually recognized by time-divisional output of image lights of the respective colors using a single liquid crystal panel, a DMD, or the like.

The projection system 143 forms and projects an image of the full-color image light on the screen 20. The projection system 143 is an optical system including at least one projection lens and may include a zoom lens, a focus lens, or the like.

The imaging device 15 captures an imaging range SA as a space in an imaging direction and generates captured image data corresponding to a captured image S. For example, the imaging range SA is shown in FIG. 5. The imaging device 15 includes a light receiving system such as a lens, an imaging device converting the light collected by the light receiving system into an electrical signal, etc. The imaging device is e.g. a CCD (Charge Coupled Device) image sensor receiving a light in a visible light range. As will be described later, the imaging device 15 is placed so that the projection direction of the image by the optical device 14 and the imaging direction coincide and the imaging range SA contains the whole projectable range NA.

The imaging device 15 may be provided separately from the other elements of the projector 10. In this case, the imaging device 15 and the projector 10 may be mutually connected by a wired or wireless interface for transmission and reception of data. In this case, the position relationship between the imaging range SA of the imaging device 15 and the projectable range NA of the optical device 14 is calibrated in advance.

The memory device 16 is a storage medium readable by the processing device 17. The memory device 16 includes e.g. a non-volatile memory and a volatile memory. The non-volatile memory includes e.g. a ROM (Read Only Memory), an EPROM (Erasable Programmable Read Only Memory), and an EEPROM (Electrically Erasable Programmable Read Only Memory) . The volatile memory includes e.g. a RAM.

The memory device 16 stores a control program 162 executed by the processing device 17 and various kinds of data 164 used by the processing device 17. The control program 162 is executed by the processing device 17. The control program 162 includes e.g. an operating system and a plurality of application programs. The data 164 includes the input image data corresponding to the input image I and shape information E, which will be described later. The data 164 includes calibration data for associating coordinates of the projectable range NA on the captured image S with coordinates on a frame memory.

The processing device 17 includes e.g. one or more processors. In an example, the processing device 17 includes one or more CPUs (Central Processing Units). Part or all of the functions of the processing device 17 may be configured by a circuit such as a DSP (Digital Signal Processor), an ASIC (Application Specific Integrated Circuit), a PLD (Programmable Logic Device), or an FPGA (Field Programmable Gate Array). The processing device 17 executes various kinds of processing in parallel or sequentially.

The processing device 17 reads the control program 162 from the memory device 16 and executes the program, and thereby, functions as a captured image acquirer 170, a projection controller 171, a designation acceptor 172, a shape information generator 173, a correction processor 174, and a correction amount determinator 175. The processing device 17 is an example of a control device. The details of the respective function units of the processing device 17 will be described later.

### C. Details of Image Projection by Projector 10

### C-1. Types of Images

FIG. 3 shows types of images relating to the display system 1. The images relating to the display system 1 include the input image I, a corrected image C, the projected image G, and the captured image S.

The input image I is e.g. an image supplied from the image supply apparatus via the communication device 13. The input image I is substantially input image data and the user recognizes the contents thereof by e.g. projection of the input image I as the projected image G or display of the input image on a display (not shown).

The corrected image C is an image obtained by correction processing on the input image I. The correction processing includes keystone correction processing of correcting deformation of the projected image G due to misalignment of the projection direction of the projector 10 with respect to the screen 20 and distortion correction processing of correcting deformation of the projected image G due to distortion of the projection surface of the screen 20, which will be described later. The corrected image C is substantially corrected image data and the user recognizes the contents thereof by e.g. projection of the corrected image C as the projected image G or display of the corrected image on a display (not shown).

The object of the correction processing is not limited to the input image I, but may be the corrected image C. For example, when the screen 20 bends during projection of the corrected image C, additional correction is performed on the corrected image C being projected and a new corrected image C is generated. The additional correction includes changing the correction amount in the corrected image C. Hereinafter, an image as an object of the correction processing is referred to as “image to be corrected CX”. The image to be corrected CX is the input image I or the corrected image C.

The projected image G is an image projected on the screen 20. The projected image G is projected on the screen 20 as an image that can be visually recognized by the user as a result of driving of the optical device 14 by the image signal generated using the input image I or the corrected image C. Hereinafter, the input image I or the corrected image C as the source of the image signal is referred to as “image to be projected GX”. The projected image G is an example of a first image and a second image.

The appearance of the projected image G may differ depending on e.g. the position of a viewer of the projected image G. Further, the appearance of the projected image G may differ depending on e.g. the condition of the screen 20. Specifically, the appearance of the projected image G projected on the screen 20 may differ between the condition that the cloth 22 of the screen 20 is tensed to form a flat surface or the bending condition.

The captured image S is an image captured by the imaging device 15. In the embodiment, the captured image S is mainly an image obtained by capture of the projected image G projected on the screen 20. The appearance of the projected image G from the imaging direction of the imaging device 15 may be grasped by the captured image S obtained by capture of the projected image G. The captured image S is substantially captured image data and the user recognizes the contents thereof by e.g. projection of the captured image S as the projected image G or display of the captured image on a display (not shown).

### C-2. Details of Input Image I

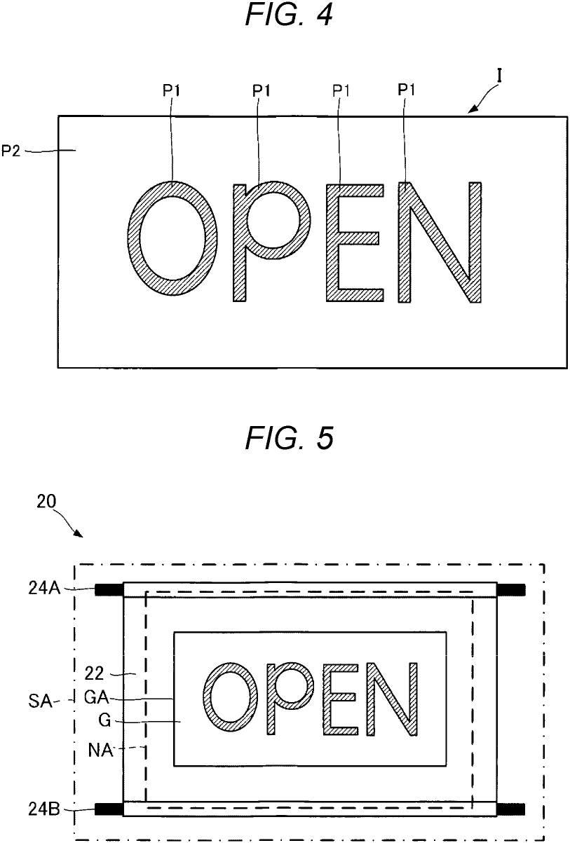

FIG. 4 schematically shows an example of the input image I. In the embodiment, the input image I contains first portions P1 and a second portion P2 different from the first portions P1. The first portions P1 are character images showing alphabets of “OPEN”. The second portion P2 is a partial area not containing the first portions P1 of a background image as a background of the first portions P1.

The first portions P1 are not limited to the character images, but may be images that can be discriminated from the second portion P2 with the contours as boundaries. The first portions P1 may be arts or photographs of e.g. characters, people, animals, or the like or logos.

The background image as the second portion P2 may be a solid color image, an image in which repeatedly appearing patterns are placed, or a gradation image of colors. The background image as the second portion P2 may be a photograph or a painting.

In the embodiment, the first portions P1 and the second portion P2 are in the same layer in the input image I. Therefore, also, in the corrected image C generated based on the input image I, the first portions P1 and the second portion P2 are in the same layer. It is considered that, for example, in an editing process of the input image I, work of superimposing the character images configuring the first portions P1 on the background image configuring the second portion P2 or the like is performed. However, it is assumed that, at the time when the input image I is input to the projector 10 as the input image data, the character images and the background image are synthesized and e.g. information of hue of the parts of the background image on which the character images are superimposed or the like is deleted.

The first portions P1 and the second portion P2 may be placed in different layers in the input image I. For example, when the projector 10 is the so-called interactive projector, writing can be performed by handwriting or the like on the background image and saved. When the input image I is the written image, the first portion P1 is a drawn image showing a handwritten character or the like and the second portion P2 is a background image.

### C-3. Relationship Between Imaging Range Sa And Projectable Range Na

FIG. 5 is an explanatory diagram schematically showing the imaging range SA of the imaging device 15. In FIG. 5 and the subsequent drawings, the hanging string 26 of the screen 20 is not shown. In FIG. 5, the imaging range SA of the imaging device 15 is shown by dashed-dotted lines and the projectable range NA of the optical device 14 is shown by dashed lines. The area contained in the imaging range SA is imaged as the captured image S. The imaging range SA contains the whole projectable range NA. That is, the captured image S is captured to contain the whole range in which images can be projected by the projector 10.

In the example of FIG. 5, the projected image G is displayed in a part of the projectable range NA. The projected image G is an image obtained by projection of the input image I shown in FIG. 4 or the corrected image C by correction of the input image I. Of the projectable range NA, a range in which the projected image G is projected is referred to as “projection range GA”. Generally, the projection range GA is determined by e.g. the aspect ratio of the input image I corresponding to the projected image G and the scaling factor settings and the display position settings by the user.

### C-4. Details of Processing Device 17

As described above, the processing device 17 reads the control program 162 from the memory device 16 and executes the program, and thereby, functions as the captured image acquirer 170, the projection controller 171, the designation acceptor 172, the shape information generator 173, the correction processor 174, and the correction amount determinator 175.

The captured image acquirer 170 acquires the captured image S captured by the imaging device 15. In the embodiment, for example, while the projector 10 projects images on the screen 20, the captured image acquirer 170 may continuously acquire the images on the screen 20. As described above, the captured image S contains the whole projectable range NA in the optical device 14. Therefore, the whole area of the projected image G is captured in the captured image S.

The projection controller 171 generates an image signal for driving the optical device 14 using image data of the image to be projected GX. The image signal generated by the projection controller 171 is input to the optical device 14.

The designation acceptor 172 receives input for designation of the first portions P1. The designation acceptor 172 receives a designation of a range HA containing the first portions P1 using e.g. the projected image G projected on the screen 20. When the range HA is designated, the designation acceptor 172 stores the insides of the contours contained in the range HA as the first portions P1.

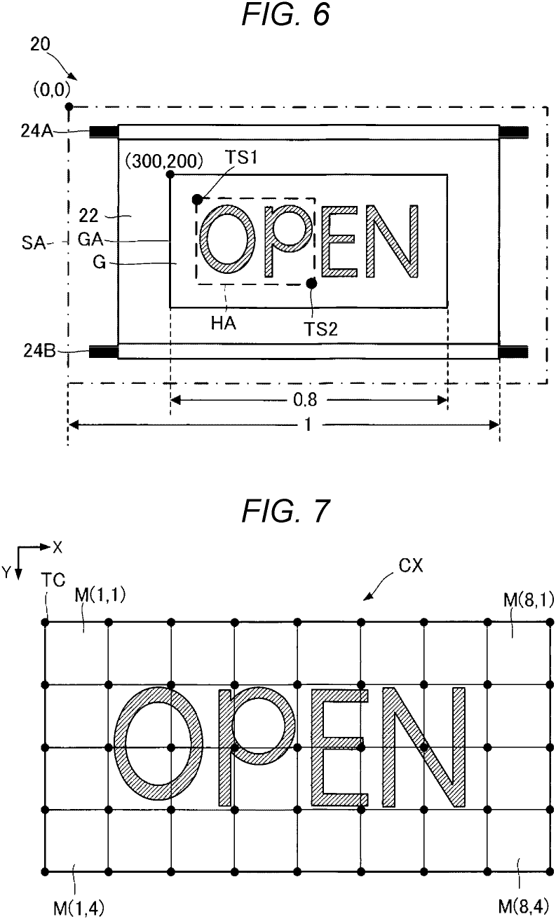

FIG. 6 schematically shows a method of receiving the designation of the first portions P1 by the designation acceptor 172. When the user performs a predetermined operation using the operation device 12 with the projected image G projected on the screen 20, a designation mode of the first portions P1 is started. In the designation mode of the first portions P1, pointers TS1 and TS2 for designation of the range HA are displayed on the projected image G. The pointer TS1 is used for designation of a point on the upper left of the range HA. The pointer TS2 is used for designation of a point on the lower right of the range HA. The user moves the pointers TS1 and TS2 to desired positions on the projected image G using the operation device 12. When the user performs an operation of “SET” or the like, the range HA is settled. For example, when the range HA is set in the state shown in FIG. 6, the parts showing the characters “0” and “P” are designated as the first portions P1. In this case, characters “E” and “N” are not used for generation of the shape information E to be described later.

The designation of the first portions P1 is not necessarily performed on the projected image G, but, for example, the input image I may be displayed on a touch panel as an example of the operation device 12 and a designation by the pointers TS1 and TS2 may be performed on the touch panel. For example, a range having any shape may be designated by the user sliding a finger on the touch panel, not designating the rectangular area by the pointers TS1 and TS2.

The designation acceptor 172 does not necessarily receive the designation of the first portions P1 from the user, but the processing device 17 may automatically specify the first portions P1. For example, when the projected image G is projected, the processing device 17 specifies an object as a center in the projected image G by the same edge extraction processing as that of the shape information generator 173, which will be described later. The object as the center refers to a character part of “OPEN” in the projected image G shown in FIG. 6 etc. The processing device 17 specifies a part of the object as the center in the projected image G as the first portions P1. That is, the processing device 17 may determine the first portions P1 by extracting the contours contained in the captured image S.

The shape information generator 173 generates the shape information E representing the shape of the first portions P1 when the screen 20 is seen from a first direction. The shape information E generated by the shape information generator 173 is stored in the memory device 16. The first direction is the imaging direction of the imaging device 15 and, in the embodiment, the same as the projection direction of an image by the optical device 14.

The shape information generator 173 sets one of the captured images S acquired by the captured image acquirer 170 as a first captured image S1. It is preferable that the projected image G is projected on the screen 20 in an ideal condition at the capture time of the first captured image S1. The ideal condition refers to e.g. a condition in which the screen 20 is positioned perpendicular to the projection direction and no bend is produced in the cloth 22, that is, no distortion, shift, or the like is produced in the projected image G.

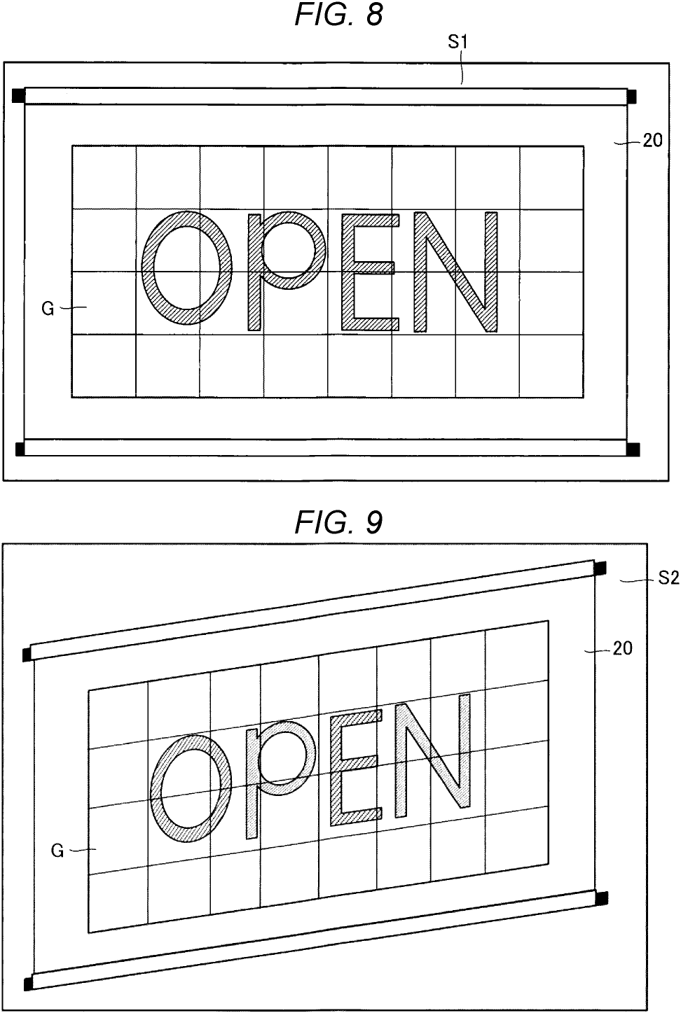

FIG. 8 is an explanatory diagram schematically showing an example of the first captured image S1. Line segments shown inside of the first captured image S1 are line segments for sectioning of areas M set for specification of the corrected part in the correction processor 174, which will be described later, and do not actually appear in the first captured image S1. In the first captured image S1, the screen 20 is positioned perpendicular to the projection direction and no bend is produced in the cloth 22. Therefore, in the first captured image S1, no distortion, shift, or the like is produced in the projected image G.

The shape information E generated from the first captured image S1 is referred to as “first shape information E1”. The shape of the first portions P1 represented by the first shape information E1 is referred to as “first shape”. The shape information generator 173 stores the first shape information E1 representing the first shape as the shape of the first portions P1 when the screen 20 is seen from the first direction.

The shape information generator 173 performs edge detection processing known in related art using e.g. a differential filter or a Laplacian filter on the captured image S and detects the four corners of the projected image G and the contours of the first portions P1. The shape information generator 173 generates the shape information E for specification of the shapes of the contours of the first portions P1. In the embodiment, the shape information E includes aggregate of coordinate data of the contours of the first portions P1. For example, the shape information generator 173 specifies the coordinates of the respective points configuring the contours of the first portions P1 with the upper left corner of the projected image G as reference coordinates (0,0) on the captured image S. The aggregate of the coordinates is the shape information E. The coordinates contained in the shape information are connected to form the line segments showing the contours of the first portions P1. The shape information E also contains the coordinates of the four corners of the projected image G.

For example, as shown in FIG. 6, the coordinates of the upper left point of the captured image S are (0,0) and the coordinates of the upper left point of the projected image G on the captured image S are (300,200). The size ratio of the whole captured image S to the projected image G appearing in the captured image S is 0.8. In this case, by subtraction of (300, 200) from the coordinate values in the captured image S and multiplication by 0.8, and thereby, the coordinate values may be transformed into the coordinate values with the upper left of the projected image G as the reference coordinates (0,0).

That is, the imaging device 15 acquires the first captured image S1 by imaging the first portions P1 from the first direction. The shape information generator 173 generates the first shape information E1 representing the first shape based on the first captured image S1. With reference to the processing device 17, the acquisition of the first captured image S1 may be acquisition of the first captured image S1 from the imaging device 15 by the captured image acquirer 170. In this case, the captured image acquirer 170 acquires the first captured image S1 obtained by imaging the first portions P1 from the first direction.

The shape information generator 173 repeatedly generates the shape information E based on the captured image S, for example, while the projector 10 projects the images on the screen 20. This is because the visual recognition condition of the projected image G may change, for example, when the screen 20 bends due to an influence by wind. The captured image S captured after the first captured image S1 is referred to as “second captured image S2”. The shape information E generated using the second captured image S2 is referred to as “second shape information E2”. The shape of the first portions P1 represented by the second shape information E2 is referred to as “second shape”.

That is, the imaging device 15 acquires the second captured image S2 by imaging the first portions P1 from the first direction after acquisition of the first captured image S1. The shape information generator 173 generates the second shape information E2 by detecting the shape of the first portions P1 appearing in the second captured image S2. With reference to the processing device 17, the acquisition of the second captured image S2 may be acquisition of the second captured image S2 from the imaging device 15 by the captured image acquirer 170. In this case, the captured image acquirer 170 acquires the second captured image S2 by imaging the first portions P1 from the first direction after the acquisition of the first captured image S1.

When the first portions P1 in the second captured image S2 are specified, a known method of feature point matching is used. Specifically, points coincident with the feature points of the shape of the first portions P1 specified by the first shape information E1 are extracted from within the second captured image S2 and the first portions P1 in the second captured image S2 are specified. According to the method, even when distortion is produced in the first portions P1 appearing in the second captured image S2, matching to the first shape information E1 can be determined.

The correction processor 174 performs correction processing on the image to be corrected CX and generates the corrected image C. The correction processing by the correction processor 174 is executed based on a correction amount determined by the correction amount determinator 175, which will be described later. FIG. 7 is an explanatory diagram schematically showing the image to be corrected CX. As shown in FIG. 7, the correction processor 174 divides the image to be corrected CX into a plurality of rectangular areas M and sets correction points TC at the four vertices of the areas M. The correction processor 174 may generate the corrected image C obtained by deformation of the image to be corrected CX by shifting the positions of the respective correction points TC. In geometrical correction, amounts of movement of the respective correction points TC are the correction amounts.

Here, the horizontal axis of the image to be corrected CX is an X-axis and the vertical axis is a Y-axis. In the example of FIG. 7, the image to be corrected CX is equally divided into eight parts along the X-axis and equally divided into four parts along the Y-axis, that is, the image to be corrected CX is divided into 32 areas M. Hereinafter, when the individual areas M are specified, the area is referred to as “area M[X,Y]”. For example, the upper left area M of the image to be corrected CX is referred to as “area M[1,1] and the lower right area M is referred to as “area M[8,4]”. The areas M containing the first portions P1 are the areas M[2,2], M[3,2], M[4,2], M[5,2], M[6,2], M[7,2], M[2,3], M[3,3], M[4,3], M[5,3], M[6,3], and M[7,3].

The correction amount determinator 175 determines the correction amounts in the correction processor 174. The correction amount determinator 175 detects the change of the shape of the first portions P1 appearing on the screen 20 using the shape information E generated by the shape information generator 173. Specifically, for example, when there is a difference between the second shape information E2 and the first shape information E1, the correction amount determinator 175 determines that the shape of the first portions P1 as seen from the imaging direction of the imaging device 15 changes.

FIG. 9 is an explanatory diagram schematically showing an example of the second captured image S2. In the second captured image S2, the screen 20 is inclined relative to the projection direction and the projected image G appears obliquely distorted as seen from the imaging direction. The second shape information E2 generated from the second captured image S2 is different information from the first shape information E1 generated from the first captured image S1 shown in FIG. 8. Therefore, the correction amount determinator 175 determines that the shape of the first portions P1 as seen from the first direction changes.

When the shape of the first portions P1 as seen from the first direction changes to the different shape from the first shape, the correction amount determinator 175 determines the correction amounts for the projected image G to make the shape of the first portions P1 as seen from the first direction closer to the first shape. Here, the correction amounts are not set for the second portion P2. The correction processor 174 performs correction based on the correction amounts determined in the correction amount determinator 175 on the image to be projected GX. That is, when the shape of the first portions P1 as seen from the first direction changes to the different shape from the first shape, the correction processor 174 performs correction to make the shape of the first portions P1 as seen from the first direction closer to the first shape on the image to be projected GX. The correction amounts for the second portion P2 are not set, and the correction processor 174 does not perform the correction on the second portion P2. The projected image G obtained by projection of the corrected image C corrected in the above described manner is the second image. The correction is performed on the image to be projected GX, and thereby, the shape of the projected image G is corrected. That is, the first image is corrected.

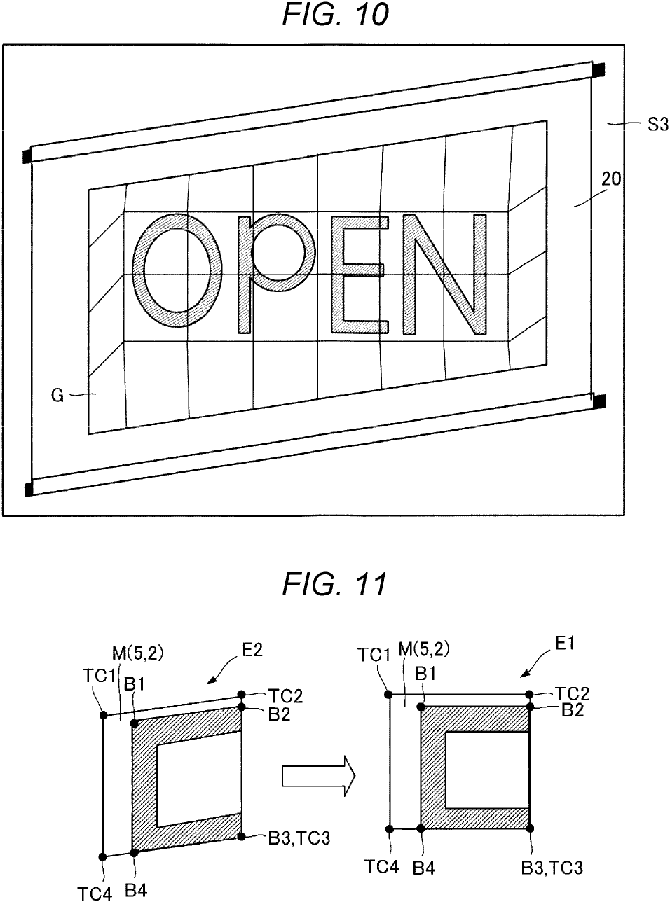

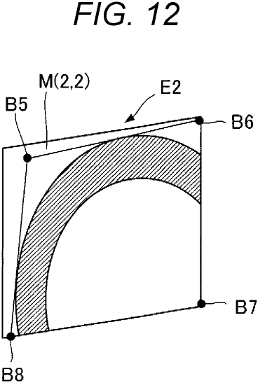

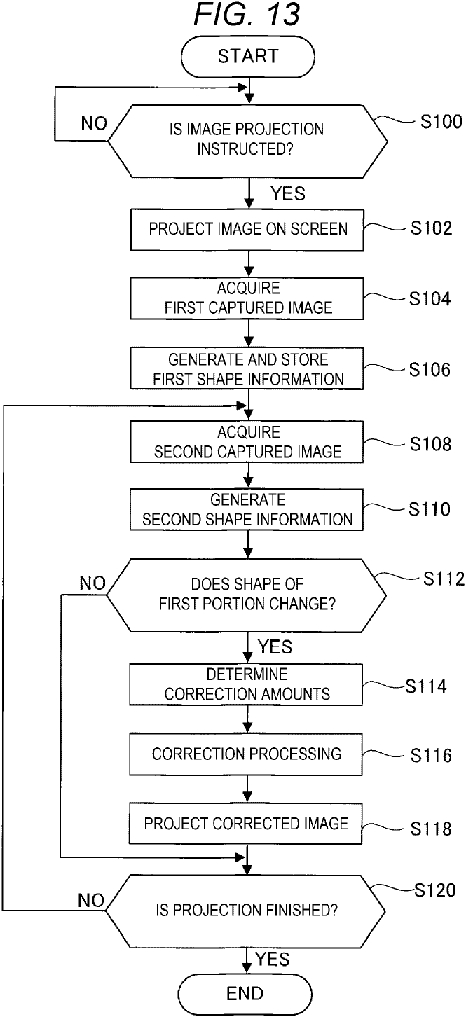

FIGS. 11 and 12 are explanatory diagrams schematically showing a method of determining the correction amounts. The left part in FIG. 11 is an extraction of a part corresponding to the area M[5,2] from the second shape information E2. The right part in FIG. 11 is an extraction of a part corresponding to the areaM[5,2] from the first shape information E1. Correction points of the area M[5,2] are TC1 to TC4.

The correction amount determinator 175 detects the four corners of the contours of the first portions P1 in the respective areas M. For example, points B1 to B4 are four corners of the contour of the first portion P1 in the area M[5,2]. The point B1 is on the upper left corner, the point B2 is on the upper right corner, the point B3 is on the lower right corner, and the point B4 is on the lower left corner. The correction amount determinator 175 determines the correction amounts of the correction points TC1 to TC4 to make the arrangement of the points B1 to B4 of the second shape information E2 closer to the arrangement of the points B1 to B4 of the first shape information E1.

For example, in a case of the area M in which the shape of the first portion P1 is a curve like e.g. the area M[2,2], the four corners of the contours form a shape of points B5 to B8 in FIG. 12. The contours of the first portions P1 are determined to include all of the contours of the first portions P1 located in the areas M and minimize the area of the quadrangle formed by the contours. The quadrangle may be a square, a rectangular, or a parallelogram.

For example, the correction amount determinator 175 first determines the correction amounts in the area M[2,2] located on the upper left of the areas M containing the first portions P1. More specifically, the correction amount determinator 175 determines the correction amount of the correction point TC1 to make the coordinates of the point B1 in the second shape information E2 as close to the coordinates of the upper left point B1 in the first shape information E1 as possible. Then, with reference to the correction point TC1, the correction amounts of the other correction points TC2 to TC4 are determined to make the coordinates of the points B2 to B4 in the second shape information E2 as close to the coordinates of the points B2 to B4 in the first shape information E1 as possible, respectively.

After the correction amounts of the correction points TC1 to TC4 of the area M[2,2] are determined, the correction amount determinator 175 sequentially determines the correction amounts at the correction points TC of the areas M adjacent to the area M[2,2]. For example, the upper left correction point TC and the lower left correction point TC of the area M[3,2] contact the correction points TC2 and the TC3 of the area M[2,2], and the correction amounts are already determined. Accordingly, the correction amount determinator 175 sequentially determines the upper right correction point TC and the lower right correction point TC of the area M[3,2]. Here, the correction amount determinator 175 determines the correction amounts of the respective correction points TC to make the coordinates of the vertices of the contours of the first portion P1 in the area M[3,2] of the second shape information E2 as close to the coordinates of the vertices of the contours of the first portion P1 in the area M[3,2] of the first shape information E1 as possible.

The correction amount determinator 175 determines the correction amounts of the respective correction points TC of the areas M containing the first portions P1 by repeating the above described processing. After determining all of the correction amounts at the correction points TC of the areas M containing the first portions P1, the correction amount determinator 175 outputs the correction amounts at the respective correction points TC to the correction processor 174 and the correction processor 174 performs correction on the image to be corrected CX.

That is, the correction amount determinator 175 determines the correction amounts in the correction by comparing the shape of the first portions P1 based on the second captured image S2 to the first shape. More specifically, the correction amount determinator 175 divides the area containing the first portions P1 of the image to be projected GX into two or more rectangular areas M and compares the shape of the first portions P1 based on the second captured image S2 to the first shape, and thereby, determines the correction amounts for the respective correction points TC in the respective areas M.

FIG. 10 is an explanatory diagram schematically showing an example of a third captured image S3 as the captured image S after the correction processing. In the third captured image S3, like the second captured image S2 shown in FIG. 9, the screen 20 is inclined relative to the projection direction and the contour of the projected image G appears obliquely distorted as seen from the imaging direction. On the other hand, regarding the first portions P1, like the first captured image S1, the screen 20 appears positioned perpendicular to the projection direction. In the above described manner, even when the screen 20 moves with respect to the projection direction or bends, the visibility of the first portions P1 of the projected image G is not lower. Therefore, for example, when the first portions P1 include character information, the character information may be easily transmitted to a viewer of the screen 20. Further, the display change with the movement of the screen 20 is different between the second portion P2 as the background and the first portions P1, and thereby, visual effects not obtained in related art may be provided to the viewer. For example, in the embodiment, the whole shape of the projected image G changes with the movement of the screen 20, the part of the characters appear immobile, and an impression as if the characters float above the background may be provided to the viewer.

### C-5. Operation of Processing Device 17

FIG. 13 is a flowchart showing a flow of a display method executed by the processing device 17 of the projector 10 according to the control program 162. The processing device 17 waits, for example, until image projection is instructed by a predetermined operation on the operation device 12 (step S100: NO). The instruction of image projection may be e.g. an instruction to start image projection or an instruction to switch display from the image to be projected GX being currently projected to another image to be projected GX. When image projection is instructed (step S100: YES), the processing device 17 functions as the projection controller 171 and projects the image to be projected GX on the screen 20 (step S102). The image to be projected GX may be the input image I or e.g. a corrected image C on which necessary correction such as keystone correction is performed.

When the image to be projected GX is displayed as the projected image G on the screen 20, the processing device 17 functions as the captured image acquirer 170 and acquires the first captured image S1 from the imaging device 15 (step S104). The processing device 17 functions as the shape information generator 173 and generates the first shape information E1 representing the shape of the first portions P1 appearing in the first captured image S1. The shape represented by the first shape information E1 is the first shape. The generated first shape information E1 is stored in the memory device 16 (step S106).

Then, the processing device 17 functions as the captured image acquirer 170 and acquires the second captured image S2 from the imaging device 15 (step S108). The processing device 17 functions as the shape information generator 173 and generates the second shape information E2 for specification of the shape of the first portions P1 appearing in the second captured image S2 (step S110).

The processing device 17 functions as the correction amount determinator 175 and determines whether or not the shape of the first portions P1 changes to a different shape from the first shape by comparing the second shape information E2 to the first shape information E1 (step S112). When the shape of the first portions P1 does not change (step S112: NO), the processing device 17 moves the processing to step S118. On the other hand, when the shape of the first portions P1 changes to a different shape from the first shape (step S112: YES), the processing device 17 functions as the correction amount determinator 175 and determines the correction amounts of the respective correction points TC in the areas M containing the first portions P1 in the image to be projected GX to make the shape of the first portions P1 closer to the shape in the first shape information E1 (step S114). The processing device 17 functions as the correction processor 174 and performs the correction processing on the image to be projected GX based on the correction amounts determined at step S114 and generates the corrected image C (step S116). The processing device 17 functions as the projection controller 171 and projects the corrected image C as a new image to be projected GX on the screen 20 (step S118).

The processing device 17 returns to step S108, for example, until an end of the image projection is instructed by a predetermined operation on the operation device 12 (step S120: NO), and repeats the subsequent processing. Then, when the end of the image projection is instructed (step S120: YES), the processing device 17 ends the processing according to the flowchart.

### D. Overview of Embodiment

As described above, the display method according to the embodiment includes performing correction on the projected image G to make the shape of the first portions P1 as seen from the first direction closer to the first shape and not performing the correction on the second portion P2 when the shape of the first portions P1 displayed on the screen 20 changes to a different shape from the first shape. In this manner, even when the screen 20 moves with respect to the projection direction or bends, the visibility of the first portions P1 of the projected image G is hard to be lower. Therefore, for example, when the first portions P1 include character information, the character information may be easily transmitted to a viewer of the screen 20. Further, the display change with the movement of the screen 20 is different between the second portion P2 as the background and the first portions P1, and thereby, the viewer may experience the visual effects not obtained in related art.

The display method according to the embodiment includes acquiring the first captured image S1 by imaging of the first portions P1 from the first direction and generating the first shape information E1 based on the first captured image S1. The display method according to the embodiment includes generating the second shape information E2 based on the second captured image S2 captured after the capture of the first captured image S1 and determining the correction amounts in the correction by comparing the shape of the first portions P1 based on the second shape information E2 to the first shape. Thereby, the correction amounts may be determined based on the real appearance of the first portions P1 and the accuracy of the correction may be improved.

The display method according to the embodiment includes dividing the area containing the first portions P1 of the image to be projected GX into two or more rectangular areas M and determining the correction amounts for the correction points TC in the respective areas M. Thereby, only the first portions P1 of the image to be projected GX including the first portions P1 and the second portion P2 may be corrected and the visual effects not obtained in related art may be provided to the projected image G.

The display method according to the embodiment includes receiving input to designate the first portions P1 from the user by the designation acceptor 172. Thereby, the user may designate arbitrary portions as the first portions P1 and the degree of freedom of the display format of the projected image G may be improved.

In the display method according to the embodiment, the first portions P1 are automatically determined by extraction of the contours in the projected image G, and thereby, the efforts to designate the first portions P1 by the user may be saved and the convenience may be improved.

In the display method according to the embodiment, when the first portions P1 and the second portion P2 are placed in the same layer, different visual effects may be provided to parts in the same layer and the degree of freedom of the display format of the projected image G may be improved.

The projector 10 according to the embodiment performs correction on the projected image G to make the shape of the first portions P1 as seen from the first direction closer to the first shape and does not perform the correction on the second portion P2 when the shape of the first portions P1 displayed on the screen 20 changes to a different shape from the first shape. In this manner, even when the screen 20 moves with respect to the projection direction or bends, the visibility of the first portions P1 of the projected image G is hard to be lower. Therefore, for example, when the first portions P1 include character information, the character information may be easily transmitted to a viewer of the screen 20. Further, the display change with the movement of the screen 20 is different between the second portion P2 as the background and the first portions P1, and thereby, the viewer may experience the visual effects not obtained in related art.

The processing device 17 according to the embodiment executes the control program 162, and thereby, performs correction on the projected image G to make the shape of the first portions P1 as seen from the first direction closer to the first shape and does not perform correction on the second portion P2 when the shape of the first portions P1 displayed on the screen 20 changes to a different shape from the first shape. In this manner, even when the screen 20 moves with respect to the projection direction or bends, the visibility of the first portions P1 of the projected image G is hard to be lower. Therefore, for example, when the first portions P1 include character information, the character information may be easily transmitted to a viewer of the screen 20. Further, the display change with the movement of the screen 20 is different between the second portion P2 as the background and the first portions P1, and thereby, the viewer may experience the visual effects not obtained in related art.

The processing by the processing device 17 in the embodiment may be executed by a plurality of processing devices. For example, an image processing circuit may be provided separately from the processing device controlling the entire of the projector 10. The image processing circuit performs image processing on input image data and converts the data into image signals. The image processing circuit is formed using e.g. an integrated circuit. The integrated circuit includes an LSI (Large Scale Integration), an ASIC, a PLD, an FPGA, and an SoC (System on chip). A part of the configuration of the integrated circuit may include an analog circuit.

What is claimed is:

1. A display method comprising:
displaying a first image including a first portion and a second portion different from the first portion on a screen by a projector;
storing information representing a first shape which is a shape of the first portion when the screen is seen from a first direction; and
when the shape of the first portion as seen from the first direction changes to a shape different from the first shape, displaying, by the projector, a second image obtained by performing correction on the first image to make the shape of the first portion as seen from the first direction closer to the first shape, and not performing the correction on the second portion on the screen.

2. The display method according to claim 1, wherein
the storing includes:
acquiring a first captured image by capturing the first portion from the first direction; and
generating the information representing the first shape based on the first captured image.

3. The display method according to claim 2, wherein
the displaying the second image includes:
acquiring a second captured image by capturing the first portion from the first direction after acquiring the first captured image; and
determining a correction amount for the correction by comparing the first shape with the shape of the first portion based on the second captured image.

4. The display method according to claim 3, wherein
the determining the correction amount includes:
dividing an area containing the first portion of the first image into two or more rectangular areas; and
determining the correction amounts for respective correction points in the respective rectangular areas by the comparing.

5. The display method according to claim 1, further comprising receiving input to designate the first portion.

6. The display method according to claim 1, further comprising determining the first portion by extracting a contour contained in the first image.

7. The display method according to claim 1, wherein
the first portion and the second portion are in a same layer in the first image.

8. A projector comprising:
an optical device; and
a control device controlling the optical device, wherein
the control device executes
displaying a first image including a first portion and a second portion different from the first portion on a screen using the optical device,
storing information representing a first shape which is a shape of the first portion when the screen is seen from a first direction, and
when the shape of the first portion as seen from the first direction changes to a shape different from the first shape, displaying, using the optical device, a second image obtained by performing correction on the first image to make the shape of the first portion as seen from the first direction closer to the first shape, and not performing the correction on the second portion on the screen.

9. A non-transitory computer-readable storage medium storing a program for causing a processing device to execute:
displaying a first image containing a first portion and a second portion different from the first portion on a screen by the projector;
storing information representing a first shape which is a shape of the first portion when the screen is seen from a first direction; and
when the shape of the first portion as seen from the first direction changes to a shape different from the first shape, displaying, by the projector, a second image obtained by performing correction on the first image to make the shape of the first portion as seen from the first direction closer to the first shape, and not performing the correction on the second portion on the screen.
